(19) United States
(12) Patent Application Publication
(10) Pub. No.: US 2011/0292038 A1
(43) Pub. Date: Dec. 1, 2011

(54) 3D VIDEO CONVERSION

(75) Inventor: BRIAN R. KELLISON, San Diego, CA (US)

(73) Assignee: Sony Computer Entertainment America, LLC, Foster City, CA (US)

(21) Appl. No.: 13/108,678

(22) Filed: May 16, 2011

Related U.S. Application Data
(60) Provisional application No. 61/349,161, filed on May 27, 2010.
(60) Provisional application No. 61/354,168, filed on Jun. 11, 2010.

(51) Int. Cl. G06T 15/00

(52) U.S. Cl. 345/419

(57) ABSTRACT

According to an embodiment of the present invention, a primary stream of video frames derived from 3D video game console can be packed into time multiplexed format in which left eye and right eye images are packed into a single frame. The stream of frames can be coupled into first and second image processors. The first image processor zooms and vertically shifts the left eye image from each frame in the primary stream to produce a first output stream of left eye images. The second image processor zooms and vertically shifts the right eye image from each frame in the primary stream to produce a second output stream of left eye images. The first and second output streams can be fed into a 3D video recording device and stored in a dual image video format. Alternatively, the first and second output streams can be fed into a dual image video projection device for real-time projection of 3D video from the game console.

### CLAIM OF PRIORITY BENEFIT

This application claims the priority benefit of commonly-assigned, co-pending U.S. provisional patent application No. 61/349,161, filed May 27, 2010, and entitled “3D VIDEO CONVERSION” the entire disclosures of which are incorporated herein by reference.

This application claims the priority benefit of commonly-assigned, co-pending U.S. provisional patent application No. 61/354,168, filed Jun. 11, 2010, and entitled “3D VIDEO CONVERSION” the entire disclosures of which are incorporated herein by reference.

### FIELD OF THE INVENTION

Embodiments of the present invention are directed to three-dimensional (3D) video and more specifically to conversion of 3D video from one format to another.

### BACKGROUND OF THE INVENTION

Three-dimensional motion picture systems have been around since the 1950's. Most systems are based on the fact that in human vision the brain combines information from two-dimensional images obtained by the right and left eyes to perceive depth. Early systems obtained left and right images using two synchronized cameras placed side-by-side to obtain slightly different images of the same scene. The two sets of images were projected simultaneously onto a screen through a projector having two lenses through different color filters. For example, the left eye image might be projected through a red colored filter and the right eye image through a blue colored filter. Members of an audience viewing the images wore glasses with red colored filters over the left eye and blue colored filters over the right eye. More recent 3D motion picture and video systems substituted different polarization filters for the different colored filters in the projection system.

Such 3D systems worked reasonably well for motion pictures projected on a screen but less so for images displayed on a video monitor, such as a television screen. Polarization-based 3D systems are generally regarded as superior to color-based systems because the color filtering is the same for each eye. Unfortunately, there is no practical way to display two different images with two different polarizations on a standard video monitor.

Recently, 3D video monitor systems have been developed that utilize time-multiplexing to present the left eye and right eye images on a monitor. The left eye and right eye images for each 3D video frame are packed together into a single frame. The left and right images for each frame displayed in an alternative fashion on the screen. A viewer wears a pair of shutter glasses with separate shutters over the left and right eyes. When the left eye image is presented the right eye shutter is closed and vice versa. Such 3D systems are often used in conjunction with video game consoles for 3D video games.

It is often desirable to project the video from a 3D video game onto a screen for display to a large audience. However, because 3D video game systems utilize time multiplexing with shutter glasses and 3D projection systems use dual image projection and passive glasses it is extremely difficult and often impossible to convert 3D game video to a format suitable for projection. One way to convert 3D game video for projection is to take the packed frames from video image and, through software processing, separate out the left and right eye images and copy them onto a medium such as video tape or video disk in a format suitable for presentation with a 3D video projector. Although this technique works well enough, it is quite slow. For example, using this technique it can take up to three seconds to convert a single 3D packed frame into dual image format for projection. Consequently, it can take several hours to convert a few minutes of 3D game video to projection format. Such a slow rate of conversion makes it impossible to do real-time projection of live 3D game video.

It is within this context that embodiments of the present invention arise.

### BRIEF DESCRIPTION OF THE DRAWINGS

The teachings of the present invention can be readily understood by considering the following detailed description in conjunction with the accompanying drawings, in which:

FIG. 1A is a schematic diagram of an example of a method for converting time multiplexed three-dimensional (3D) video to a dual image format according to an embodiment of the present invention.

FIG. 1B is a schematic diagram of an example of a system for converting time multiplexed three-dimensional (3D) video to a dual image format according to a first alternative embodiment of the present invention.

FIG. 2 is a schematic diagram of an example of a system for converting time multiplexed three-dimensional (3D) video to a dual image format according to a second alternative embodiment of the present invention.

FIG. 3 is a schematic diagram of an example of a system for converting time multiplexed three-dimensional (3D) video to a dual image format according to a third alternative embodiment of the present invention.

FIG. 4 is a schematic diagram of an example of a system for converting time multiplexed three-dimensional (3D) video to a dual image format according to a fourth alternative embodiment of the present invention.

FIG. 5 is a schematic diagram of an example of a system for converting time multiplexed three-dimensional (3D) video to a dual image format according to a fifth alternative embodiment of the present invention.

### DESCRIPTION OF THE SPECIFIC EMBODIMENTS

Although the following detailed description contains many specific details for the purposes of illustration, anyone of ordinary skill in the art will appreciate that many variations and alterations to the following details are within the scope of the invention. Accordingly, the exemplary embodiments of the invention described below are set forth without any loss of generality to, and without imposing limitations upon, the claimed invention.

Embodiments of the present invention implement solutions to the problem of live projection of 3D game video in real time.

According to embodiments of the present invention, a primary stream of video frames derived from 3D video game console can be packed into time multiplexed format in which left eye and right eye images are packed into a single frame. The stream of frames can be coupled into first and second image processors. The first image processor zooms and vertically shifts the left eye image from each frame in the primary stream to produce a first output stream of left eye images. The second image processor zooms and vertically shifts the right eye image from each frame in the primary stream to produce a second output stream of left eye images. The first and second output streams can be fed into a 3D video recording device and stored in a dual image video format. Alternatively, the first and second output streams can be fed into a dual image video projection device for real-time projection of 3D video from the game console.

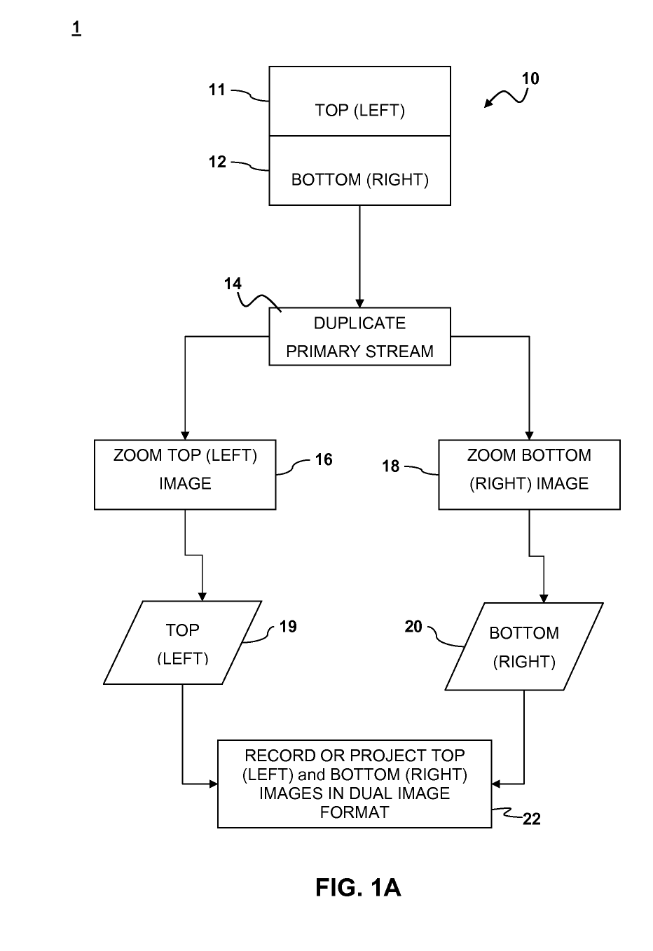

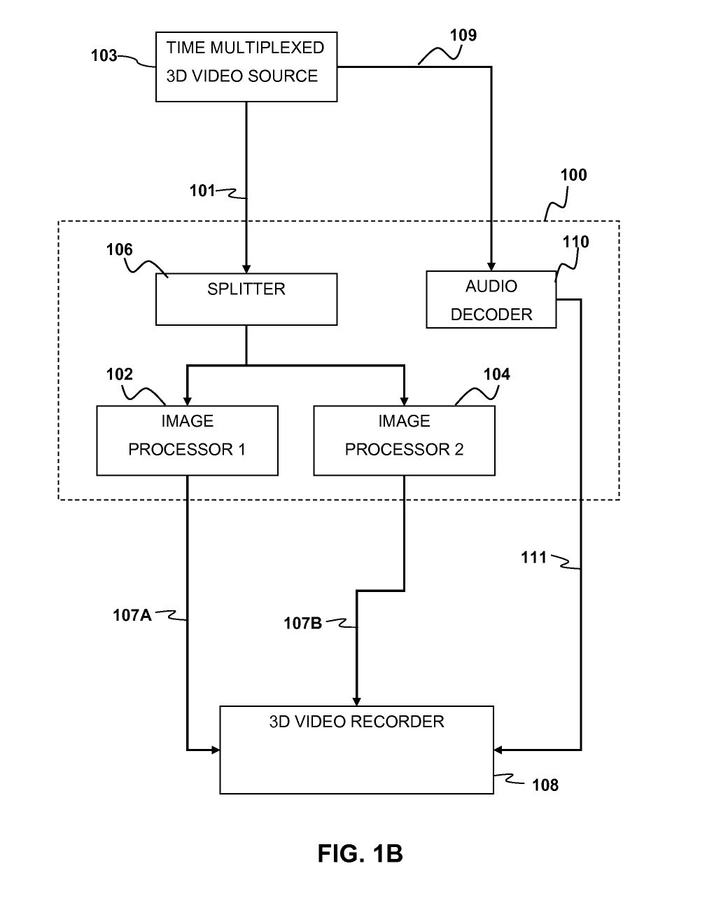

FIG. 1A illustrates an example of a method 1 for converting time multiplexed three-dimensional video to a dual image format according to an embodiment of the present invention. A primary stream of video frames 10 is derived from a source in a time multiplexed format in which a left eye image 11 and a right eye image 12 are packed into a single frame. The primary stream is coupled into first and second video image processors. To do this, the stream may be duplicated to form first and second primary streams as indicated at 14. However, splitting the primary stream with a splitter is not strictly necessary. As indicated at 16, the left eye image 11 from each frame 10 in the primary stream is zoomed and vertically shifted with the first image processor to produce a first output stream of left eye images 19. In a similar fashion, the second image processor can zoom and vertically shift the right eye image 12 from each frame 10 in the primary stream, as indicated at 18, to produce a second output stream of right eye images 20.

As indicated at 22, the first and second output streams can be coupled into a 3D video recording device for storage in a dual image video format or coupled into a dual image video projection device for real-time projection of 3D video from the source.

FIG. 1B illustrates an example of a system 100 for converting time multiplexed three-dimensional (3D) video to a dual image format according to a first alternative embodiment of the present invention. In this example, the system 100 can be configured to convert a time multiplexed primary video stream 101 from a source 103 into a dual image format for recording on a conventional 3D video recorder. The source 103 can be any suitable source of 3D video in time multiplexed format. By way of example and not by way of limitation, the source 103 can be a video game console such as a PlayStation 3 from Sony Computer Entertainment of Tokyo, Japan.

The system 100 generally includes a first video image processor 102 and a second video image processor 104. By way of example and not by way of limitation, the first and second video image processors may be ImagePro HD image processors commercially available from Barco Media & Entertainment of Rancho Cordova, Calif. Such image processors allow full control of a 1280×1470 59.94 Hz video image. By way of example and not by way of limitation, the primary stream 101 can be fed into a splitter 106, e.g., a DVI 1:2 splitter from Gefen, Inc. of Chatsworth, Calif., to produce first and second primary streams 101A, 101B, which can be coupled to the first and second image processors respectively.

It is possible for the source to produce the primary stream 101 in High Definition Multimedia Interface (HDMI) format and for the image processors to the use Digital Visual Interface format since these two signal formats are electrically compatible. In such a case, the source 103 can be coupled to the splitter by an HDMI-VDI cable.

The first image processor 102 can be set to zoom in on the top/left image 11 and produce a first output 107A containing left eye images. In a like manner, the second image processor 104 can be set to zoom in on the bottom/right image 12 and produce a second output 107B. By way of example the first and second image processors can be set to zoom in the respective images by 200% and underscan by about 12-13% to allow the bottom/right eye image to bleed through from the top/left eye image. An operator can monitor the outputs of the image processors with one or more standard video monitors in real time to properly adjust the zoom and vertical shift settings to obtain the desired alignment of the first and second video outputs. The output of each processor 102, 104 can be set to a suitable size for a dual image format. For example, in the case where the primary stream is in 1280×1470 59.94 Hz format, the first and second output streams 107A, 107B can be in 1280×720p. 59.94 Hz format.

In some cases, the top/left eye image may need to be offset vertically by a few lines (e.g., +33 to 34 lines of pixels) and the bottom/right eye image may need to be offset by an equal and opposite amount (e.g., −33 to 34 lines of pixels).

The first and second output 107A, 107B can be coupled into a suitably configured 3D video recorder or 3D video projector that uses a dual image video format. By way of example, and not by way of limitation, the first and second outputs 107A, 107B can be connected to a 3D video recorder 108, such as a HDCAM-SRW 5800 Studio Recorder from Sony, of Tokyo, Japan.

It is noted that in some cases it may be useful or necessary to extract a separate audio signal from the source 103 and couple to an audio input of the recorder 108. For example, the image processors 102, 104 may remove the audio from the primary signal 101. In such a case, a separate channel for the audio output from the source 103 that is independent of the primary stream 101 may be necessary. By way of example, an audio signal 109 from the source 103 may be coupled to the recorder 108. Specifically, a fiber optic audio output or other audio output separate from the primary video signal 101 could be coupled to an audio decoder 110, such as a Dolby DP564 Multichannel Audio Decoder from Dolby Laboratories of San Francisco, Calif. A multichannel output 111 of the audio decoder 110 can be fed to an audio input of the recorder 108 in a suitable digital audio standard, such as AES/EBU.

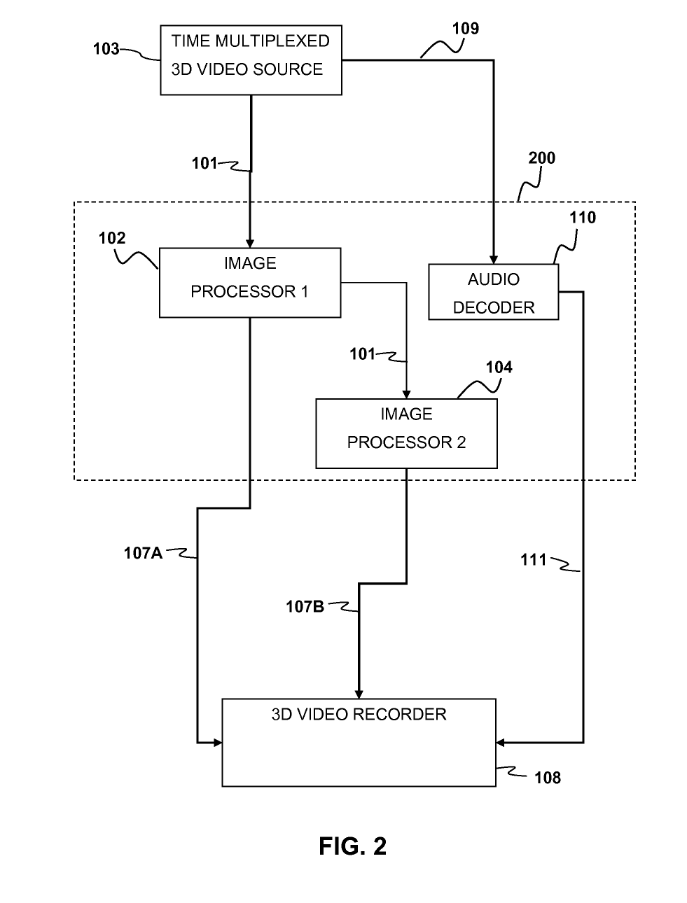

Several variations on the system of FIG. 1B are possible. For example, as shown in FIG. 2 in an alternative system 200 for converting time multiplexed three-dimensional (3D) video to a dual image format according to a second alternative embodiment can omit the splitter 106. Instead, the primary stream 101 may be coupled into the first image processor 102 from the source 103 and coupled from the first image processor 102 to the second image processor 104. By way of example, the primary stream 101 can be coupled from the first image processor 102 to the second image processor in DVI format if the image processors only have that format and loop through.

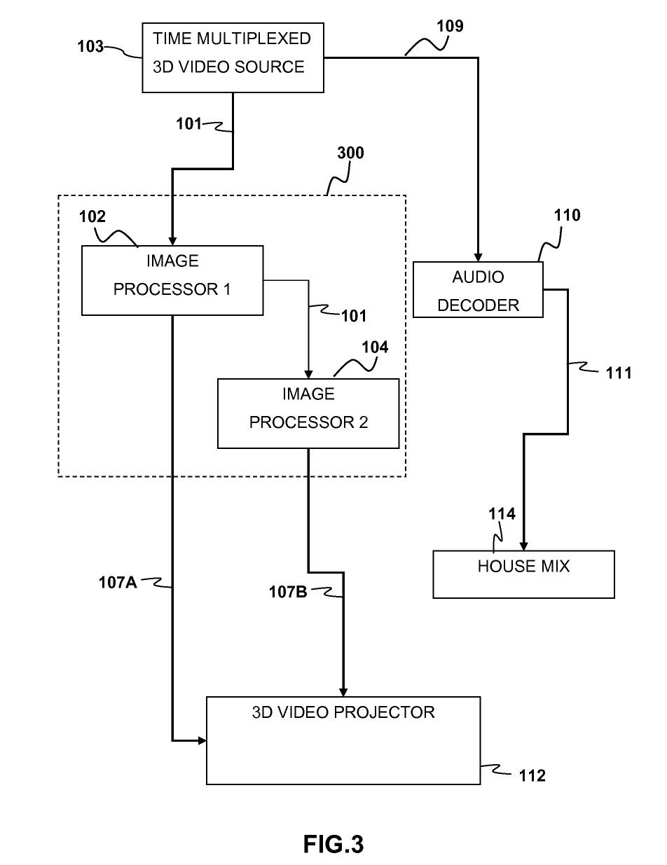

As seen in FIG. 3, another alternative system 300 for converting time multiplexed three-dimensional (3D) video to a dual image format according to a third alternative embodiment may include just the first and second image processors 102, 104 configured as described above. In this example, the first and second outputs 107A, 107B can be coupled from the first and second image processors 102, 104 to a conventional 3D projector 112, which can project left eye and right eye image streams in a conventional manner. The audio output 109 of the source can be coupled to a multi-channel audio decoder 110, which can provide multi-channel audio output to the house mix 114 for an audio system associated with the projector 112. It is noted that the house mix 114 may be a completely separate system and unit from the projector 112.

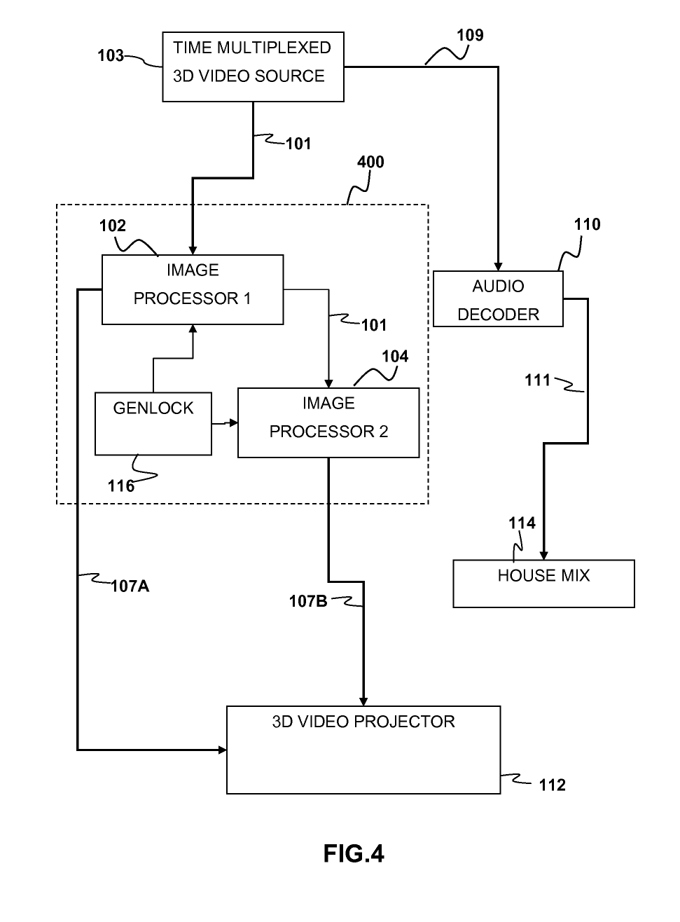

In some implementations, it may be useful to synchronize the outputs of the two image processors 102, 104 with each other and/or with the audio signal output 109 or 111. One way to implement such synchronization is through use of a generator lock (also referred to as a genlock). By way of example, and not by way of limitation, FIG. 4 illustrates an example of yet another alternative system 400 for converting time multiplexed three-dimensional (3D) video to a dual image format that includes a reference 116 coupled to the first and second image processors 102, 104 to synchronize the first and second outputs 107A, 107B so that the left and right images do not drift vertically with respect to each other.

A Genlock is a common technique where the video output of one source, or a specific reference signal, is used to synchronize other television picture sources together. The aim in video and digital audio applications is to ensure the coincidence of signals in time at a combining or mixing or switching point. When sources are synchronized in this way, they are said to be genlocked.

By way of example, the reference lock 116 can produce an analog genlock signal containing vertical and horizontal synchronizing pulses together with chrominance phase reference in the form of color burst. The genlock signal may omit picture information to avoid disturbing the timing signals. The name reference, black and burst, color black, or black burst is usually given to such a signal.

The example depicted in FIG. 4 is similar to the example depicted in FIG. 3 in that the outputs 107A, 107B are coupled to a 3D projector and a separate audio output of the source 103 is coupled to the audio house mix 114 for the sound system associated with the projector. It is noted that embodiments of the invention are not limited to such implementations and that other variations are possible.

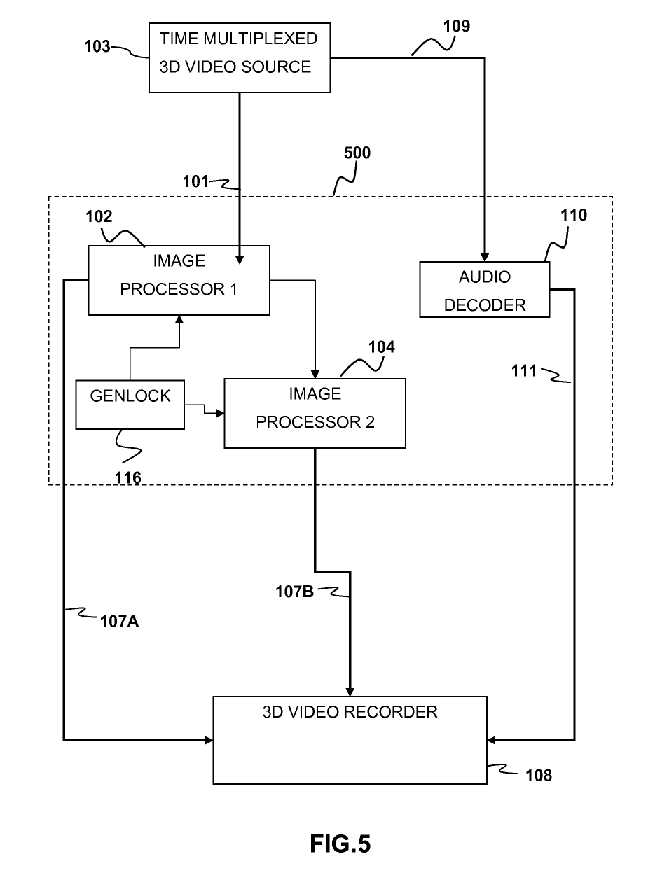

For example, as depicted in FIG. 5, the genlocking technique depicted in FIG. 4 may be implemented in a system 500 that includes first and second image processors 102, 104 that can provide the first and second outputs 107A, 107B to a 3D video recorder 108 as discussed above with respect to FIG. 1B. The system 500 can also include a multi-channel audio decoder 110 that con provide multi-channel audio output 111 to the 3D video recorder 108.

While the above is a complete description of the preferred embodiment of the present invention, it is possible to use various alternatives, modifications and equivalents. Therefore, the scope of the present invention should be determined not with reference to the above description but should, instead, be determined with reference to the appended claims, along with their full scope of equivalents. Any feature described herein, whether preferred or not, may be combined with any other feature described herein, whether preferred or not. In the claims that follow, the indefinite article “A”, or “An” refers to a quantity of one or more of the item following the article, except where expressly stated otherwise. The appended claims are not to be interpreted as including means-plus-function limitations, unless such a limitation is explicitly recited in a given claim using the phrase “means for.”

What is claimed is:

1. A method for converting time multiplexed three-dimensional (3D) video to a dual image format, comprising:
a) coupling a primary stream of video images from a source to first and second video image processors, wherein the primary stream of video frames is in a time multiplexed format in which a left eye image and a right eye image are packed into a single frame;
b) zooming and vertically shifting the left eye image from each frame in the primary stream with the first image processor to produce a first output stream of left eye images;
c) zooming and vertically shifting the left eye image from each frame in the primary stream with the second image processor to produce a second output stream of right eye images;
d) coupling the first and second output streams into a 3D video recording device for storage in a dual image video format or coupling the first and second output streams into a dual image video projection device for real-time projection of 3D video from the source.

2. The method of claim 1, wherein the source is a video game console.

3. The method of claim 1 wherein a) includes splitting the primary stream into first and second primary streams with a splitter and coupling the first primary stream to the first image processor and coupling the second primary stream to the second image processor.

4. The method of claim 1 wherein a) includes coupling the primary video stream into one of the first or second image processor and coupling the primary stream from the one of the first or second image processor to the other of the second or first image processor.

5. The method of claim 1, further comprising extracting an audio signal output from the source that is separate from the primary stream and coupling the audio signal output to an audio input of the recording device or an audio system associated with the video projection device.

6. The method of claim 1, further comprising time synchronizing the first and second output streams.

7. A system for converting time multiplexed three-dimensional (3D) video to a dual image format, comprising:
a) a first video image processor configured to receive a primary stream of video frames from a source in a time multiplexed format in which a left eye image and a right eye image are packed into a single frame,
wherein the first video image processor is configured to zoom and vertically shift the left eye image from each frame in the primary stream with the first image processor to produce a first output stream of left eye images; and
b) a second video image processor configured to receive the primary stream;
wherein the first video image processor is configured to zoom and vertically shift the left eye image from each frame in the primary stream to produce a first output stream of left eye images
wherein the second video image processor is configured to zoom and vertically shift the right eye image from each frame in the primary stream to produce a second output stream of left eye images.

8. The system of claim 7, further comprising a 3D video recording device coupled to the first and second video image processors and configured to receive the first and second output streams and store the first and second output streams in a dual image video format.

9. The system of claim 7, further comprising a 3D video projection device coupled to the first and second video image processors and configured to receive the first and second output streams and projecting left and right eye images from the source in real time.

10. The system of claim, further comprising the source of the primary stream of video frames, wherein the source is coupled to the first and second video image processing devices.

11. The system of claim 10, wherein the source is a video game console.

12. The system of claim 7, further comprising a splitter configured to receive the primary stream into first and second primary streams and couple the first primary stream to the first image processor and couple the second primary stream to the second image processor.

13. The system of claim 7 wherein the first and second image processors are coupled to each other in such a way that one of the first or second image processor can receive the primary stream and transmit the primary stream to the other of the second or first image processor.

14. The system of claim 7, further comprising an audio decoder configured to extract an audio signal output from the source that is separate from the primary stream and couple the audio signal output to an audio input of a recording device or an audio system associated with a video projection device.

15. The system of claim 7, further comprising a video signal synchronizing device coupled to the first and second video image processors and configured to time synchronize the first and second output streams.
